(19) United States
(12) Patent Application Publication
(10) Pub. No.: US 2024/0144187 A1
(43) Pub. Date: May 2, 2024

(54) Semi-Automated Construction Superintendent Field Controller

(71) Applicant: Ben Martin, Guntersville, AL (US)

(72) Inventor: Ben Martin, Guntersville, AL (US)

(21) Appl. No.: 18/483,883

(22) Filed: Oct. 10, 2023

Related U.S. Application Data
(60) Provisional application No. 63/421,750, filed on Nov. 2, 2022.

(51) Int. Cl. G06Q 10/10; G06Q 50/08

(52) U.S. Cl. CPC G06Q 10/103; G06Q 50/08

(57) ABSTRACT

A construction superintendent field control device is disclosed that eliminates defects by preventing them during the construction process. The construction superintendent field control device comprises a rugged, indoor, and outdoor computing component that connects to a chassis component controlled by an operator or that is used as a portable, handheld tool. The device requires an operator to locate and move the device within the operating field. The device perceives and interacts with construction documentation and the environment by hardware, sensors and software while knowing its position. The device uses image processing for measuring and comparing real to digital information.

### CROSS-REFERENCE TO RELATED APPLICATION

The present application claims priority to, and the benefit of, U.S. Provisional Application No. 63/421,750, which was filed on Nov. 2, 2022, and is incorporated herein by reference in its entirety.

### FIELD OF THE INVENTION

The present invention relates generally to the field of construction technology. More specifically, the present invention relates to a semi-automated computerized information system designed to collect, filter, process, store and distribute construction site information. By giving the construction superintendent a technological tool to enhance their cognitive and physical abilities to sense, process, act, and report on the changing conditions in the construction field. Allowing for greater insight into the operations on the site. Advancing a more reliable near real time remote monitoring and controlling operation. By integrating information and communications technology into one platform. To improve quality, documentation, communication, efficiency, and productivity during the construction process. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to a new and innovative semi-automated construction superintendent monitoring and control system. This device's hardware and software enhances the ability of the superintendent to have advanced speed and quality in achieving situational understanding during the construction process. Generally, cognitive workload, maintaining control and reporting are all separate issues and extremely difficult to manage at the same time without the superintendent field controller described in this invention. Especially, when the bulk of business is operating manually with a word processor, camera, cell phone and a whole lot of time spent cognitively and physically. Such as activities to include quality control, subcontract management, project details, task management, communications, schedule updates and look ahead, progress tracking, material management, equipment, tools, and assembly processes. All these and more are mostly manual. Another aspect is the fragmented project data from file folders, and spreadsheets or word file formats to manage and update is daunting. Each of these elements are extremely time consuming, error prone, and can negatively affect profitability, cash flow, and repeat business.

Generally, more so, errors, mistakes and defects that have not been identified and corrected during the earlier stages of the construction process end up being dealt with during execution. These and other nonconformities can lead to significant delays, increase costs, and require constant rework by the construction superintendent. Further, construction costs have increased due to the manual, repeated failure of our construction superintendent field control process to resolve preconstruction issues while in execution. Thus, operations related to construction superintendent field control enablement can lead to less time to perform corrective and preventative action while in execution.

Although the construction industry is a major contributor to the economy, there are many risks unique to the industry. The top construction risk includes “Losing Money” that plague the industry due to human error, communication challenges, unreliable employees, poor planning and workmanship, underestimated projects, inferior materials, scope creep, inexperienced workers and management, software that is not much more than a word processor, and standards that are inconsistent. Construction process errors are costly. Errors waste financial and material resources. Errors are very disruptive during and post-construction. Errors can lead to project failure and a bad reputation. Nonconformities, defects, and errors can be contained with improved systems and processes; however, the industry has not been given the technology to effectively mitigate, improve and control occurrences until now. This invention aims to overcome this negligence for our industry.

Accordingly, there is a demand for an improved construction management tool that can eliminate current issues within the construction process. More particularly, there is a demand for a construction superintendent field control device that prevents and eliminates issues permanently in the construction process. A device that assists and enhances the superintendent's ability to monitor and control a project at a high level of expertise.

Therefore, there exists a long-felt need in the art for a construction superintendent field control device that ensures highly effective construction management services. A device that provides users with a semi-automated tool for eliminating nonconformities from the construction process. A device that senses, processes, provides construction documentation information on demand A device that documents records quickly and accurately, with ease. A device to enhance the capability to track and update project status effortlessly. A device that can acquire information from the environment by sensors. A system that learns and applies stored past events and lessons learned to control and maintain future efforts in the construction process. Featuring an indoor and outdoor construction that can connect to the operator via a chassis system. Further, there is a long-felt need in the art for a construction superintendent field control device that is intelligent and functions as a highly effective tool. Moreover, there is a long-felt need in the art for a device that is comfortably portable, with the capability to precisely display positional information on a construction drawing as you move within the field. Further, there is a long-felt need in the art for a construction superintendent field control device that can function as an offline device and interact with popular software applications while, sense, processing, recording, while documenting positional and perceptual information on digital plans and/or other central reporting applications with a few buttons, display screen, sensors, and software. Finally, there is a long-felt need in the art for a construction superintendent field control device that helps eliminate defects from prior construction process phases during the construction execution process.

The construction superintendent field control device is a convenient and portable electronic device that enhances the ability of the superintendent to manage the operations on the construction site. This highly portable device can be carried by hand or on a variety of chassis systems by the user. Such as a safety vest pack with peripherals connected to personal protective equipment. Chassis variety would depend on circumstance or operator preference. Perhaps the operators prefer a chest pack for controller and inconspicuous peripherals for perceptual data acquisition sensors. The device has computational and connectivity capacity to perform the tasks of communication management. Data entry and retrieval is simple, software and sensors do a lot of the work. This simplicity aids the operator in efficiency. Operators can use the device to assist and aid in processing perceptual and positional information while simultaneously moving. The device assists in observing events, studying materials, measuring, and checking, or performing other tasks as required. This technology and its capability of automation of construction field superintendent practices is required to make up for the limitations of human capability within time constraints. This technology also makes it possible for the operator to access needed information on demand by its project documentation search engine and chat features. All while communicating requirements to others thoroughly and documenting the process accurately semi automatically. This technology goes well beyond word processing and taking pictures.

Furthermore, superintendents are often moving about the construction site. Their responsibilities cover a wide variety of tasks that may change without notice and are often competing for their attention such as: translating English to Spanish and Spanish to English; clarifying plans and specifications, resolving differing conditions, adapting methods and materials to site-specific requirements; coordinating and scheduling events and material delivery; spending too much time with and for inadequate subcontractors; comparing planned to constructed conditions; redundantly, relaying data and communicating the same information verbally and in a text to a host of enquirers, monitoring jobsite conditions, supply levels, uses of supplies, and safety deficiencies, all while improving efficiency, and ensuring quality; recording and documenting work progress, labor, inspections, compliance to specifications, etc.; and communicating direction to specialty contractors, laborers, suppliers, etc. This device hyper enhances the superintendents performance of these duties and reduces the cognitive workload in the field semi automatically.

A considerable amount of the superintendent's job requires construction documentation that is readily available, accessible, and easily communicated to others and the company database to maintain viability of the project parameters. Accordingly, this device handles the bulk of that workload. The device is adaptable and flexible, and would lighten a user's workload, reduce stress, keep everything organized, and reduce redundancy. Everyone can stay informed in real time graphically.

The subject matter disclosed and claimed herein, in one embodiment thereof, comprises a construction superintendent field controller used in the quality control aspect. Generally, errors, mistakes and defects that have not been identified and corrected during the earlier stages of the construction process end up being dealt with during execution. These and other nonconformities that occur during the execution can lead to significant delays, increase costs, and require constant rework by the construction superintendent. Further, construction costs have increased due to the manual, repeated failure of our construction superintendent field control process to resolve preconstruction issues while in execution. Thus, operations related to construction superintendent field control enablement can lead to less time to perform corrective and preventative action while in execution. The construction superintendent field control device comprises a rugged, indoor, and outdoor computing component that can connect to a chassis component controlled or worn by an operator or that is used as a portable, handheld tool. The device comprises input sensors and software controls that can optically check and measure. Artificially compare actuals to plans and specifications, search records and documents, and positioning and perceptual information processing on a digital plan and/or central reporting applications. Further, the electronic components of the device are encased in a rigid enclosure connected to peripherals.

In this manner, the construction superintendent field control device of the present invention accomplishes all the foregoing objectives and provides users with a semi-automated system for the construction process control. The device is typically constructed using bright colors to maintain high visibility. The device can be manufactured of plastic, metal, and glass materials.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a construction superintendent field control device. The device eliminates defects by preventing them during the construction process. The construction superintendent field control device comprises a rugged, indoor, and outdoor computing component that can connect to a chassis component controlled by an operator or that is used as a portable, handheld tool. The device requires an operator to locate and move the device within the operating field, as defined by the computing component. The device then geographically displays top-down information of where the operator is within the field precisely to digital plans. Then, as the operator moves within the field, so will his or her position on the schematic drawing. The device comprises input controls and software that will both record and document positioning and perceptual information on a digital plan or other reporting applications.

In one embodiment, the construction superintendent field control device comprises a rugged, indoor, and outdoor computing component that can connect to a chassis component controlled by an operator or that is used as a portable, handheld tool. The device allows an operator to locate and move the device within the operating field, as defined by the computing component. The operating field is typically a construction site, either commercial or residential, or any other suitable place as is known in the art where the operator is trying to identify and prevent construction risks.

In one embodiment, the construction superintendent field control device utilizes, among other things, a quality assurance program based on the requirements set forth in the plans and specifications of a specific building project and contract. All are managed by the devices project information search engine. These specifications may come from an architect, engineer, and/or designer of record, a builder, a property owner, or any other interested party in a construction project. Depending on the complexity and importance of a project, these specifications may come from a combination of all the interested parties. Finally, they may be included at the suggestion of a construction materials management professional and/or based on the International Building Code.

In one embodiment, the construction superintendent field control device utilizes a software application or other software program with sensor fusion and computing hardware for positioning and perceptual data acquisition, processing, and reporting. The device will be able to perceive its surroundings but cannot actuate further processing without operator control. Such as updating information on a central database, and interacting with and writing a daily report on traditional software of all that the device has learned or processed.

In one embodiment, the construction superintendent field controller is a part of control loops. For instance, construction materials quantity and specifications are identified and uploaded into the superintendent control system from supplier. The superintendent, with the assistance of the sensory capabilities within the device, can assure the right amounts and types of materials are on site or their status. The materials specifications and quantities are stored in the construction superintendent field control system and the device compares, deducts, and references construction documentation to and from the supplier during the construction process. The device also helps to track material use. Then wirelessly transmitted by operator control for reporting to central system. The construction superintendent field control central system produces graphical representations of the materials and results in 2- and 3-dimensions illustration being continually updated, as subsequent materials are identified and recorded. Simultaneously, we have documentation of progress for reporting and information for look ahead scheduling as well. The construction superintendent field control device also logs the specific operator or user activity, so that the user of the device is accountable for their activities, as more than one construction superintendent field control may log construction activity. Specifically, small construction projects may involve only a single user or operator, while larger and more complicated construction projects will involve multiple control devices with different users or operators.

In one embodiment, the device can be used offline or with a software license. Thus, the operator's location, interactions with their environment, as well as the operator's perceptual information can be tracked and recorded, then either submitted wirelessly to a central server system (i.e., connected to one or more servers having a central database) in real-time or recorded offline and transmitted later when the device is on-line with a service connection. The central server system may be a dedicated server computer, or it may be a secure cloud service. The software utilized with the construction superintendent field control device can be sold to and downloadable onto customer servers, or in another example, it may be licensed over the cloud as a service.

In one embodiment, the device further comprises a plurality of input controls that are used to both record, document, measure, compare and process natural language. Allowing a user to do more work in the same amount of time, as he/she moves through the construction site. Without lugging all the measuring tools and the loss of train of thought when interrupted. Further, the electronic input control components for the device are encased in a rigid enclosure connected to peripherals for processing and communication within the device as is known in the art.

In some aspects, the present invention provides a device by which builders can manage and maintain control throughout a residential or commercial construction project. In some embodiments, for an operator, user, or other builder personnel, the device may provide options to give directions to a non-English speaking person. Or automatically mark a digital plan of all the areas that were checked with the device capability as you walk through. With measurements. For example, an operator may perform a site walk at a job site. During which the operator walks through with the device. The digital plans on the device are being annotated with measurements and dimensionally compared to specs automatically if the device is instructed too. If a defect has been identified with the device sensors or operators' perception. That defect information will be documented by the device automatically or manually if the operator wants to override. The device will be able to identify what trade has the defect. The device gives you a prompt for action. With a click of a button to proceed. The central system will be updated, and the contractor responsible will be put on alert.

In some embodiments, the construction superintendent field control system allows trade partners such as suppliers to input and view delivery logistics. For example, using the devices communication capability, trade partner can schedule and review deliveries, as well as, add any relevant or important information (i.e., delivery tickets.), and designate or update the status of a particular item (i.e., not started, in progress, or completed). For example, a trade user may need a particular item in the upcoming near future. While being able to view supplier information, the user can also track the order status, communicate with suppliers, and review delivery details. Further, from this information, the device may provide an indication of any items which are urgent and/or behind schedule.

In one embodiment, the construction superintendent field control device comprises a carrying case. Specifically, when the device is employed on a trolley chassis, the trolley chassis and device can be broken down and stored in a carrying case for easy transport. The carrying case can be any suitable shape and size, if the carrying case acts to retain the chassis and device safely within. Additional space or compartments is advised for various other chassis types, etc. The carrying case can comprise a handle and/or wheels, like a suitcase, for easy transport.

In one embodiment, the construction superintendent field control device is manufactured of plastic or polymer, metal, and glass materials, as well as combinations therein. Further, the device is typically constructed using bright colors to maintain high visibility.

In operation, a user logs in and via sensor fusion is tracking within the operating field by the construction superintendent field control device. As they move through the operating field, construction information is acquired, identified, and processed. This information is relayed as input into a server computer, or it can be maintained offline. The central server, using the construction superintendent field control device, populates the information and constantly updates the control system graphics. The control system graphic information is available to other users for vital operational detailed analysis.

In yet another embodiment, the construction superintendent field control device comprises a plurality of indicia.

In yet another embodiment, a method of eliminating defects created during the construction process is disclosed. The method includes the steps of providing a construction superintendent field control device comprising a computing component that is controlled by an operator. The method also comprises locating and moving the device within the operating field. Further, the method comprises geographically displaying top-down information of where the operator is within the field. The method comprises following the operator's movement within the field and reflecting it on the schematic drawing. Finally, the method comprises inputting processed analyzed construction defects data with the computing component to the central server while the operator is moving within the field.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the construction superintendent field control device of the present invention showing an operator working with the trolley chassis in accordance with the disclosed architecture;

FIG. 2 illustrates a perspective view of one embodiment of the construction superintendent field control device of the present invention showing positional data on the display of the superintendent controller in accordance with the disclosed architecture;

FIG. 3 illustrates a perspective view of one embodiment of the construction superintendent field control device of the present invention showing the positional and perceptual data acquired, identified, and processed in accordance with the disclosed architecture;

FIG. 4 illustrates a perspective view of one embodiment of the construction superintendent field control device of the present invention showing the device and a carrying case in accordance with the disclosed architecture;

FIG. 5 illustrates a perspective view of one embodiment of the construction superintendent field control device of the present invention showing the device stored in the carrying case in accordance with the disclosed architecture; and

FIG. 6 illustrates a flowchart showing the method of eliminating defects during the construction process in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a construction superintendent field control device that can eliminate current issues within the construction process. More particularly, there is a demand for a construction superintendent field control device that prevents and eliminates issues permanently in the construction process. A device that assists in maintaining and controlling a project at a high level of expertise.

The present invention, in one exemplary embodiment, is a novel construction superintendent field control device. The device eliminates nonconformities by preventing them during the construction process. The construction superintendent field control device comprises a rugged, indoor, and outdoor computing component that can connect to a chassis component controlled by an operator or that is used as a portable, handheld tool. The device requires an operator to locate and move the device within the operating field. The device then perceives and interacts with its environment within the field under the control of the operator. Then, as the operator moves within the field, positional and perceptual information of the construction site is being monitored and controlled with the assistance of the device. This acquired information from sensory data is processed by the computing component and output is given to the operator for action. In conversational format, indicator lights, sounds as well as graphical interface depictions. The device can be used offline or with a software license. The device comprises input controls powered by artificial intelligence, machine learning, robotic process automation, and will both search construction document and report our situational awareness to central server for updating real time information graphics. The present invention also includes a novel method of eliminating defects during the construction process. The method includes the steps of providing a construction superintendent field control device comprising a computing component that is controlled by an operator. The method also comprises locating to automatically update, report and interact with the software that may be currently being used. Further, the method comprises geographically displaying top-down information of where the operator is within the field. The method comprises following the operator's movement within the field and reflecting it on the schematic drawing. Finally, the method comprises inputting.

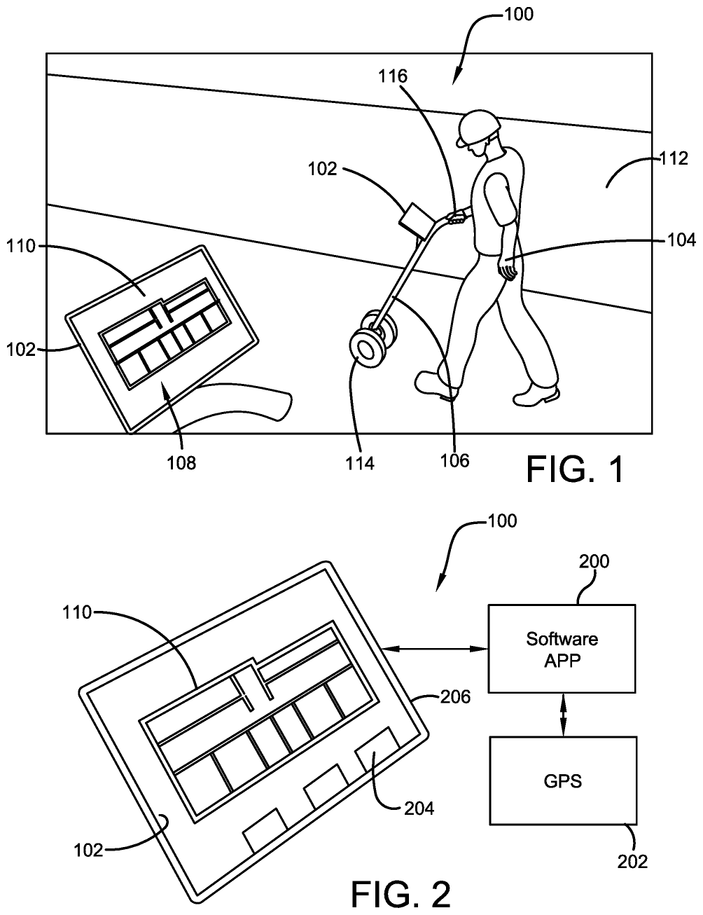

Referring initially to the drawings, FIG. 1 illustrates a perspective view of one embodiment of the construction superintendent field control device 100 of the present invention. In the present embodiment, the construction superintendent field control device 100 is an improved construction management device 100 that provides a user with a tool for eliminating nonconformities during the construction process. Specifically, the construction superintendent field control device 100 comprises a computing component with artificial intelligence and sensor fusion 102 that connects to a trolley chassis component 106 controlled by an operator 104 or that is used as a portable, handheld tool 108. Device 100 requires an operator 104 to locate and move the device 100 within the operating field, as defined by the computing component 102. The device 100 then geographically displays top-down information of where the operator 104 is within the field, precisely as his or her position is emulated on a digital plan. Then, as the operator 104 moves within the field, so will his or her position on the schematic drawing 110. Further, the device 100 will measure, level, mark up, layout, assist in estimation, track, check and manage materials, record, perceive its environment and interact with its environment and document on the digital schematic 110, traditional software, and a central server.

Generally, the construction superintendent field control device 100 comprises a rugged, indoor, and outdoor computing component 102 that connects to a chassis component 106 controlled by an operator 104 or that is used as a portable, handheld tool 108. The computing component 102 comprises a touch screen with physical buttons, similar in shape and size as a typical PMC teach pendent, mobile human machine interface or modular tactical system as is known in the art, etc., especially when used as a portable, handheld tool 108. When secured to a trolley chassis component 106, the device 100 is usually secured to a component that has wheels 114 and a handle 116 to allow the device 100 to be easily transported through the operating field 112. Further, the device 100 allows an operator 104 to locate and move the device 100 within the operating field 112, as defined by the computing component 102. Operating field 112 is typically a construction site, either commercial or residential, or any other suitable place as is known in the art where the operator 104 is trying to monitor and control at high level of expertise. Generally, the computing component 102 comprises software and peripherals to enhance the operators 104 physical and cognitive ability controlling it throughout the construction process.

Furthermore, the construction superintendent field control device 100 utilizes, among other things, a quality assurance program based on the requirements set forth in the plans and specifications of a specific building project and contract to determine and identify construction nonconformities. The device further facilitates communication and corrective action from all parties involved. These specifications may come from an architect, engineer, and/or designer of record, a builder, a property owner, or any other interested party in a construction project. Depending on the complexity and importance of a project, these specifications may come from a combination of all the interested parties. Finally, they may be included at the suggestion of a construction materials management professional and/or based on the International Building Code.

As shown in FIG. 2, the construction superintendent field control device 100 utilizes a software application 200 or other software program with sensor fusion 202, among other components, to enhance the operators 104 capability of situational understanding and management of the ever-changing circumstances within the operating field 112. Then, as the operator 104 moves within the operating field 112, so will his or her position on the schematic computer drawing 110.

Furthermore, the computing component 102 comprises a processor, which may be a CPU, a microprocessor, a controller, or any other type of computing device that may process programs and/or instructions, and which may control the other electrical components within the computing component 102. The processor also includes a transmitter/receiver, which receives and sends a signal from a mobile or smart device or a computer.

Further, the device 100 further comprises a plurality of physical buttons, sensory and touch screen input controls 204 that are used to both record and document in the digital schematic 110, allowing a user 104 to record and identify construction defects and interact with the controller more efficiently as he or she moves through the construction site 112. Further, the electronic input control components 204 for the device 100 are encased in a rigid enclosure 206 connected to peripherals for communication with a computer/laptop 208 and/or mobile device 210, or any other suitable device as is known in the art, which can access, analyze, and input with authorization for remote control purposes in the central server.

In some aspects, the present invention provides a device 100 by which builders can manage and maintain total quality management throughout a residential or commercial construction project. In some embodiments, for an operator 104, user, or other builder personnel, the device 100 may provide options to discover, acknowledge, identify, and report a delay issue of some sort to the central server 300. Central server 300 updates and puts responsible parties on alert. Central server 300 displays graphical information for analysis of what is causing the delay, who is responsible, what actions have been taken beyond putting responsible parties on alert, and how long corrective actions are taking or took. For example, operator 104 may perform a walkthrough of a job site with the controller, during which the operator 104 and controller create a real-time report of current nonconformity to schedule specifications found at the job site 112. This schedule nonconformity can then be reported to the central server 300. Central server processes and updates graphical interface and notifies the appropriate trade partner(s), notifying them of the issue and the need for necessary corrections. At the same time, the central server 300 stays aware of current issues tracking them as well as any other issue that has been input from the field controllers until issues are resolved. Central server itemizes, organizes, and can report to all appropriate parties involved.

Accordingly, the construction superintendent field control management device 100 and central server 300 allows trade partners to view, manage and be accountable for their portion of the scope. For example, using device 100, trade partner personnel may be able to view their performance details and key performance indicators. For example, a trade user may be able to view the number of nonconformities by job site and track the progress by type and/or job site. Further, from this information, the device 100 may provide an indication of any nonconformities which are urgent and/or behind schedule.

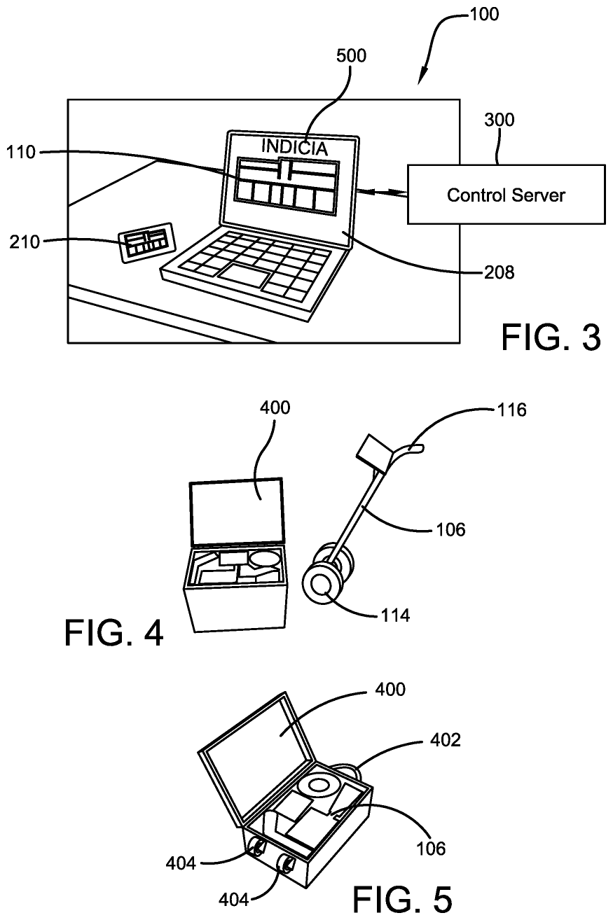

As shown in FIG. 3, real time construction data is acquired and processed in the field by the construction superintendent field control device 100 and then wirelessly transmitted to the central server 300. Central server processes construction data to save and update graphical user interface of the control system. Computer/laptop 208 or mobile device/smartphone 210 may access the graphical interface of the central server with appropriate credentials. The central server 300 produces graphical representations 110 of the processed inputs from the superintendent field control device 100 in 2 and 3 dimensions. Continually updating the central server, as subsequent data is acquired from the superintendent field control device. The construction superintendent field control device 100 also logs the specific operator 104 or user, so that the user 104 of the device 100 is accountable for their entries, as more than one user 104 may log construction data. Specifically, small construction projects may involve only a single user or operator 104, while larger and more complicated construction projects will involve multiple different users or operators 104. In this situation more superintendent field control devices 100 would be used.

Furthermore, the device 100 can be used offline or with a software license. Thus, the operator's positional and perceptual information, as well as any other monitoring and controlling activity can be tracked and recorded, then either submitted wirelessly to a central server system 300 (i.e., connected to one or more servers having a central database) in real-time or recorded offline and transmitted later when the device 100 is on-line with the central server 300. The central server system 300 may be a dedicated server computer, or it may be a secure cloud service. The software utilized with the construction superintendent field control device 100 can be sold to and downloadable onto customer servers, or in another example, it may be licensed over the cloud as a service.

As shown in FIGS. 4-5, the construction superintendent field control device 100 comprises a carrying case 400. Specifically, when the device 100 is employed on a chassis 106, the chassis 106 and device 100 can be broken down and stored in a carrying case 400 for easy transport. The carrying case 400 can be any suitable shape and size, as long as the carrying case 400 acts to retain the chassis 106 and device 100 safely within. The carrying case 400 can comprise a handle 402 and/or wheels 404, like a suitcase, for easy transport.

Generally, the construction superintendent field control device 100 is manufactured of plastic or polymer, metal, and glass materials, as well as combinations therein. Further, the device 100 is typically constructed using bright colors to maintain high visibility.

In operation, a user 104 logs in, and via sensor fusion 202 and artificial intelligence 200 is performing cognitive computing and tracing within the operating field 112 by the construction superintendent field control device 100 as indicated by the display screen, indicator lights, and chat. As moving through the operating field 112, construction activity is identified, processed, and recorded and then input into a server computer or maintained offline until sent to central server 300. The central server 300, using the construction superintendent field control device 100 processed data, then populates the information and constantly updates its own graphical interface. The information is then saved and made available to other users. Other parties involved may interact on the central server 300 by logging in with a smartphone 210 or laptop/computer 208 to visually see, interact and analyze the construction information graphically.

In yet another embodiment, the construction superintendent field control device 100 comprises a plurality of indicia 500. The computing component 102 of the device 100 may include advertising, a trademark, or other letters, designs, or characters, printed, painted, stamped, or integrated into the computing component 102, or any other indicia 500 as is known in the art. Specifically, any suitable indicia 500 as is known in the art can be included, such as, but not limited to, patterns, logos, emblems, images, symbols, designs, letters, words, characters, animals, advertisements, brands, etc., that may or may not be construction, defects, or brand related.

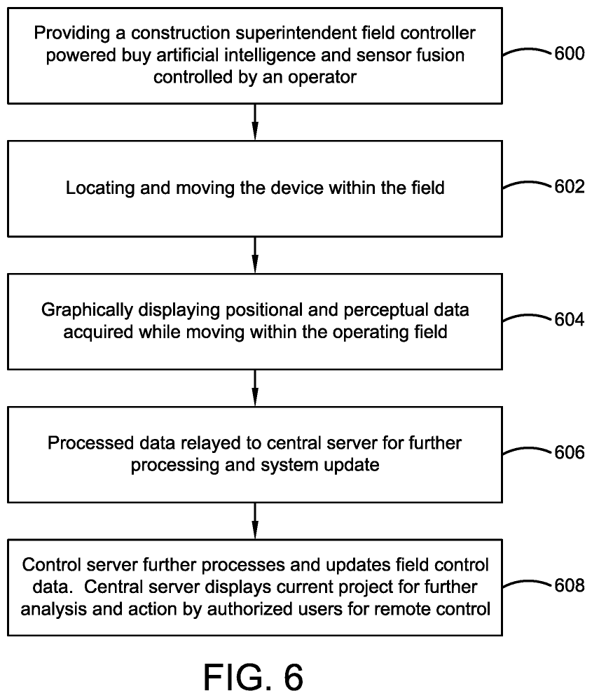

FIG. 6 illustrates a flowchart of the method of eliminating defects during the construction process. The method includes the steps of at 600, providing a construction superintendent field control device comprising a computing component, that is controlled by an operator. The method also comprises at 602, locating and moving the device within the operating field. Further, the method comprises at 604, graphically displaying processed perceptual and positional information acquired while the operator is moving within the field on the computing component device. The method comprises at 606, following the operator's movement within the field and relaying to control server for further processing and updating of server graphical interface. Finally, the method comprises at 608, inputting construction defects into the central server.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “construction superintendent field control device”, “field control device”, and “device” are interchangeable and refer to the construction superintendent field control device 100 of the present invention.

Notwithstanding the foregoing, the construction superintendent field control device 100 of the present invention can be of any suitable size and configuration as is known in the art without affecting the overall concept of the invention, provided that it accomplishes the above-stated objectives. One of ordinary skill in the art will appreciate that the construction superintendent field control device 100 as shown in FIGS. 1-6 is for illustrative purposes only, and many other sizes and shapes of the construction superintendent field control device 100 are well within the scope of the present disclosure. Although the dimensions of the construction superintendent field control device 100 are important design parameters for user convenience, the construction superintendent field control device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A construction superintendent field control device that provides a user with a tool for eliminating defects during the construction process, the construction superintendent field control device comprising:
a computing component with sensor fusion;
wherein the computing component is controlled by an operator;
wherein the computing component powered by artificial intelligence has perceptual capability including photogrammetry and positional capabilities within an operating field and performs a variety of computational tasks that facilitate control;
wherein the computing component creates and displays a schematic drawing which displays the operator's position with the operating field; and enhances the ability of the superintendent to manage the operations on and off the construction site; and
further wherein the computing component allows the operator to document at least one construction defect and acquire data while in the operating field.

2. The construction superintendent field control device of claim 1, wherein the computing component is used as a portable, handheld tool.

3. The construction superintendent field control device of claim 1, wherein the computing component connects to a chassis component controlled by the operator.

4. The construction superintendent field control device of claim 3, wherein the chassis component comprises a plurality of wheels and a handle to allow the construction superintendent filed control device to be easily transported through the operating field when in use.

5. The construction superintendent field control device of claim 4, wherein the operating field is typically a construction site.

6. The construction superintendent field control device of claim 5, wherein the computing component comprises a software application or software program with artificial intelligence, machine learning, robotic process automation and sensor fusion to precisely simulate actual operating field conditions in real time.

7. The construction superintendent field control device of claim 6, wherein the computing component comprises a software program to create and display the operator's position within the operating field via an interface.

8. The construction superintendent field control device of claim 7, wherein the software program allows the computing component to track and interact with the operator within the operating field.

9. The construction superintendent field control device of claim 8, wherein the computing component comprises a plurality of sensors and macro buttons for input controls that allow the operator to acquire and relay and report information, as he/she moves through the operating field.

10. The construction superintendent field control device of claim 9, wherein the plurality of input controls are encased in a rigid enclosure for protection.

11. The construction superintendent field control device of claim 10, wherein the plurality of input controls are connected to peripherals for communication with a surface marking device for physical layout.

12. A construction superintendent field control device of claim 11, wherein the software and hardware components provide a user with a tool to easily navigate digital plans and allow the user to verbally communicate with the construction superintendent field control device.

13. A construction superintendent field control device that provides a user with a tool for eliminating defects during the construction process, the construction superintendent field control device comprising:
a computing component with sensor fusion;
wherein the computing component is controlled by an operator;
wherein the computing component connects to a chassis component controlled by the operator;
wherein the chassis component comprises a plurality of wheels and a handle to allow the construction superintendent filed control device to be easily transported through the operating field when in use;
wherein the computing component is used as a portable, handheld tool;
wherein the computing component powered by artificial intelligence has perceptual capability including photogrammetry and positional capabilities within an operating field and performs a variety of computational tasks that facilitate control;
wherein the operating field is typically a construction site;
wherein the computing component creates and displays a schematic drawing which displays the operator's position with the operating field; and enhances the ability of the superintendent to manage the operations on and off the construction site; and
further wherein the computing component allows the operator to document at least one construction defect and acquire data while in the operating field.

14. The construction superintendent field control device of claim 13, wherein the computing component provides options to semi-automatically create reports from the acquired information, edit and update previous information on central processor.

15. The construction superintendent field control device of claim 13, wherein an operator is able to view a product or service quality issue list, as well as add any relevant or important information, and designate or update the status of a particular issue in product or service quality.

16. The construction superintendent field control device of claim 13, wherein the computing component can be used offline, and then transmitted later to the central control for updating the system when the computing component is back on-line.

17. The construction superintendent field control device of claim 13, wherein the computing component submits information wirelessly to a central server system in real-time.

18. The construction superintendent field control device of claim 13 further comprising a plurality of indicia.

19. The construction superintendent field control device of claim 13 further comprising a carrying case for transport.

20. A method of eliminating nonconformities during the construction process, the method comprising the following steps:
providing a construction superintendent field control device comprising a computing component that is controlled by an operator;
locating and moving the device within the operating field;
geographically displaying top-down information of where the operator is within the field;
following the operator's movement within the field and reflecting it on the computing component and
inputting construction defects on the computing component while the operator is moving within the field.
